(19) United States
(12) Patent Application Publication
(10) Pub. No.: US 2022/0019397 A1
(43) Pub. Date: Jan. 20, 2022

(54) SIGNAGE DEVICE AND METHOD FOR CONTROLLING SAME

(71) Applicant: SAMSUNG ELECTRONICS CO., LTD., Suwon-si (KR)

(72) Inventor: Young Gyoo PARK, Suwon-si (KR)

(73) Assignee: SAMSUNG ELECTRONICS CO., LTD., Suwon-si (KR)

(21) Appl. No.: 17/311,004

(22) PCT Filed: Aug. 27, 2019
(86) PCT No.: PCT/KR2019/010937

§ 371 Date: Jun. 4, 2021

(30) Foreign Application Priority Data
Dec. 11, 2018 (KR) 10-2018-0158805

(51) Int. Cl. G06F 3/14; G09F 9/302

(52) U.S. Cl. CPC G06F 3/1446; G09F 9/3023

(57) ABSTRACT

A signage apparatus includes a plurality of displays; a storage providing at least one content; and a controller configured to generate a new layout forming an output area of at least one display among the plurality of displays, and to control to output the at least one content through the new layout.

### TECHNICAL FIELD

The present disclosure relates to a signage apparatus and a method of controlling the same, and more particularly, to a signage apparatus for reproducing a content having a specific output ratio through various layouts and a method of controlling the same.

### BACKGROUND ART

A signage refers to a means of distributing various contents such as advertisements and various information to the public by installing a plurality of displays in public places.

A signage apparatus is connected to a server that provides the content and transmits the information to the public through the plurality of displays according to a predetermined schedule. Particularly, a manager may register the content in the server and reproduce the content based on a subject of the content and setting information of the plurality of displays.

Most of the content is provided through a display having a resolution of 16:9, and for this reason, a lot of content suitable for the 16:9 ratio is authored.

On the other hand, recently, a display apparatus of a 32:9 ratio rather than the 16:9 ratio has been introduced into a digital signage market, and a compatibility issues with ready-authored 16:9 ratio content. The disclosure below was devised to allow the ready-authored 16:9 ratio content to be reproduced in a variety of ways.

### DISCLOSURE

### Technical Problem

An aspect of the present disclosure is to provide a signage apparatus capable of reproducing ready-authored content having a specified output ratio in various arrays of a display, and a method of controlling the signage apparatus.

### Technical Solution

An aspect of the disclosure provides a signage apparatus including: a plurality of displays arranged in an irregular shape; a storage providing at least one content; and a controller configured to generate a new layout forming an output area of at least one display among the plurality of displays, and to control to output the at least one content through the new layout.

The controller may be configured to generate the new layout by integrating output areas of two or more displays adjacent to each other among the plurality of displays.

The controller may be configured to generate the new layout by dividing the output area of the display.

The controller may be configured to generate the new layout based on at least one of array information, size information, ratio information, resolution information, and rotation information of the plurality of displays.

The controller may be configured to determine a ratio of the new layout and control to output a content compatible with the ratio.

The plurality of displays may include at least one main display and at least one sub-display. The controller may be configured to control the at least one main display to output a content compatible with the new layout by setting the new layout according to a user's setting and the at least one sub display to output a content compatible with an existing layout.

The plurality of displays have a 16:9 resolution. The controller may be configured generate three new layouts with a 9:16 ratio in a horizontal direction based on the display being a horizontal array, and to generate three new layouts with a 16:9 ratio in the vertical direction based on the display being a vertical array.

The plurality of displays may include first, second, third and fourth displays having a 16:9 resolution. The controller may be configured to detect that the first, second, third, and fourth displays are arranged in a 2×2 array, to generate a new layout in which the output areas of the first, second, third, and fourth displays are integrated, and to control to output a content compatible with the new layout.

The plurality of displays may include first, second, and third displays having a 16:9 resolution. The controller may be configured to detect that the first, second, and third displays are continuously arranged in a vertical direction, to generate a new layout in which the output areas of the first, second, and third displays are integrated, and to control to output a content compatible with the new layout.

The content may include a plurality of pages authored sequentially. The plurality of displays may include a first display having a 32:9 resolution. The controller may be configured to generate a first new layout and a second new layout in which an output area of the first display is divided, and to control to sequentially output at least one page that can be output through the first new layout and the second new layout among the plurality of pages.

Another aspect of the disclosure provides a method of controlling a signage apparatus. The signage apparatus may include a plurality of displays. The method including: receiving, by a controller, at least one content so that the plurality of displays output the at least one content, and arranging the plurality of displays in an irregular shape; selecting, by the controller, a new layout forming an output area of at least one display from among the plurality of displays; and controlling, by the controller, to output the at least one content through the new layout.

The generating of the new layout forming the output area of at least one display from among the plurality of displays may include generating the new layout by integrating output areas of two or more displays adjacent to each other among the plurality of displays.

The generating of the new layout for at least one display from among the plurality of displays may include generating the new layout by integrating output areas of two or more displays adjacent to each other.

The generating of the new layout forming the output area of at least one display from among the plurality of displays may include generating the new layout by dividing the output area of the display.

The generating of the new layout forming the output area of at least one display from among the plurality of displays may include generating the new layout based on at least one of array information, size information, ratio information, resolution information, and rotation information of the plurality of displays.

The controlling to output the at least one content through the new layout may include determining a ratio of the new layout and controlling to output a content compatible with the ratio.

The plurality of displays may include at least one main display and at least one sub-display. The controlling to output the at least one content through the new layout may include controlling the at least one main display to output a content compatible with the new layout by setting the new layout according to a user's setting and the at least one sub display to output a content compatible with an existing layout.

The plurality of displays may include first, second, third and fourth displays having a 16:9 resolution. The controlling to output the at least one content through the new layout may include detecting that the first, second, third, and fourth displays are arranged in a 2×2 array, generating a new layout in which the output areas of the first, second, third, and fourth displays are integrated, and controlling to output a content compatible with the new layout.

The plurality of displays may include first, second, and third displays having a 16:9 resolution. The controlling to output the at least one content through the new layout may include detecting that the first, second, and third displays are continuously arranged in a vertical direction, generating a new layout in which the output areas of the first, second, and third displays are integrated, and controlling to output a content compatible with the new layout.

### Advantageous Effects

According to an embodiment, it is possible to secure a compatibility with a display apparatus having various ratios without modifying an output ratio of ready-authored contents.

### DESCRIPTION OF DRAWINGS

FIG. 1 is a view illustrating a server implementing a signage apparatus and a system connected to the server.

FIG. 2 is a control block diagram of a signage apparatus according to an embodiment.

FIG. 3 is a view for describing a content referred to in an embodiment.

FIG. 4 is a view for describing a divided layout referred to in an embodiment.

FIG. 5 is a view illustrating an irregular signage apparatus according to an embodiment.

FIG. 6 is a view illustrating a sensor provided in the irregular signage apparatus illustrated in FIG. 5.

FIGS. 7 and 8 are views for describing a new layout generated by an irregular signage apparatus.

FIG. 9 is a view illustrating a display for selectively multiplexing content having a plurality of pages.

FIG. 10 is a flowchart of a method of controlling a signage apparatus according to an embodiment.

### MODES OF THE INVENTION

Like reference numerals refer to like elements throughout the specification. Not all elements of the embodiments of the disclosure will be described, and the description of what are commonly known in the art or what overlap each other in the exemplary embodiments will be omitted. The terms as used throughout the specification, such as “˜ part,” “˜ module,” “˜ member,” “˜ block,” etc., may be implemented in software and/or hardware, and a plurality of “˜ parts,” “˜ modules,” “˜ members,” or “˜ blocks” may be implemented in a single element, or a single “˜ part,” “˜ module,” “˜ member,” or “˜ block” may include a plurality of elements.

It will be further understood that the term “connect” and its derivatives refer both to direct and indirect connection, and the indirect connection includes a connection over a wireless communication network.

The terms “include (or including)” and “comprise (or comprising)” are inclusive or open-ended and do not exclude additional, unrecited elements or method steps, unless otherwise mentioned.

Furthermore, when it is stated that a layer is “on” another layer or substrate, the layer may be directly on another layer or substrate or a third layer may be disposed therebetween.

It will be understood that, although the terms first, second, third, etc., may be used herein to describe various elements, components, regions, layers and/or sections, these elements, components, regions, layers and/or sections should not be limited by these terms. These terms are only used to distinguish one element, component, region, layer or section from another region, layer or section.

It is to be understood that the singular forms “a,” “an,” and “the” include plural references unless the context clearly dictates otherwise.

Reference numerals used for method steps are merely used for convenience of explanation, but not to limit an order of the steps. Thus, unless the context clearly dictates otherwise, the written order may be practiced otherwise.

Prior to the description of the present specification, some terms used in the present specification will be clarified.

A content refers to a work that can be visually transmitted through a display as a video, an image, or a text. Meanwhile, in order for the content to be output to fit on an output screen of the display, it must be authored in accordance with a size, a width and height ratio of the display during an content authoring process. In this case, information about the size and ratio is reflected to determine an output area of the content, which is referred to as a layout, and will be described in more detail below.

The layout refers to a boundary of the output area in which the content is reproduced. Basically, a ratio of the layout may be determined according to a basic specifications of a display apparatus. For example, HD (1280×720), FHD (1920×1080), and UHD (3840×2160) are adopted with a 16:9 resolution as the most widely adopted monitor in a signage field, and at this time, the ratio of the layout may be 16:9. However, recently, monitors with a resolution of 21:9 or 32:9 instead of the 16:9 resolution are being produced for general use, and are also being introduced into a digital signage market. In this case, the ratio of the layout may be 21:9 or 32:9. Meanwhile, the ratio of the layout may be set based on size information, position information, and rotation information of a plurality of displays, which will be described later in detail.

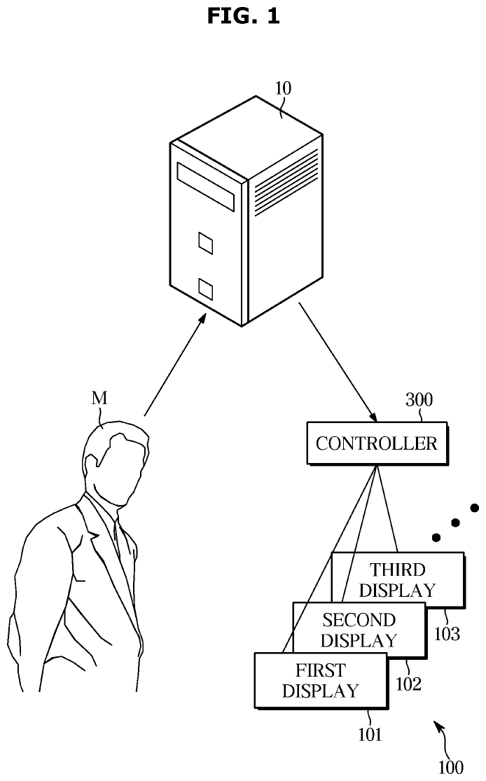

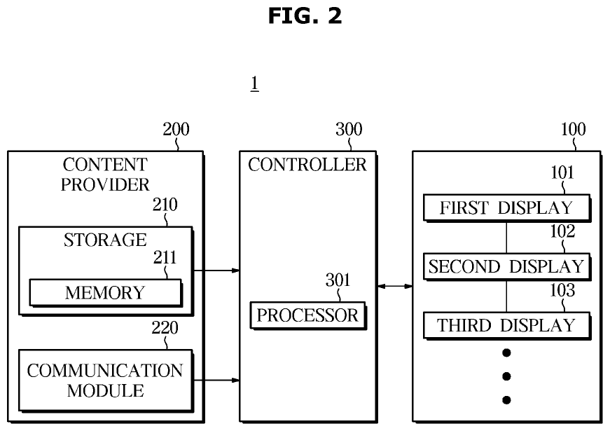

FIG. 1 is a view illustrating a server implementing a signage apparatus and a system connected to the server, and FIG. 2 is a control block diagram of a signage apparatus according to an embodiment. A signage system may include a server 10, a plurality of displays 100, and a controller 300 that integrates and controls the plurality of displays 100. This is only an embodiment for achieving the object of the disclosure, and of course, some configurations may be added or deleted as necessary. In addition, it should be noted that each of the components of the signage system illustrated in FIG. 1 represents functional elements that are functionally divided, and at least one component may be implemented in a form integrated with each other in an actual physical environment.

The server 10 may be connected to the signage apparatus 1 to provide a content authored by a manager M so that the plurality of displays 100 may output it. The signage apparatus 1 may be connected to the server 10 and may output the content based on a predetermined schedule. For example, when the manager M registers the content with the server 10 and sets a schedule such as a method and a time for reproducing the content, the signage apparatus 1 may reproduce the content according to the schedule.

In addition, the server 10 may provide an existing 16:9 ratio content and an exclusive content that can be reproduced only in a specific layout to the signage apparatus 1. In addition to the 16:9 ratio content, the server 10 may provide the authored content based on a layout using an entire video wall or a partial area thereof.

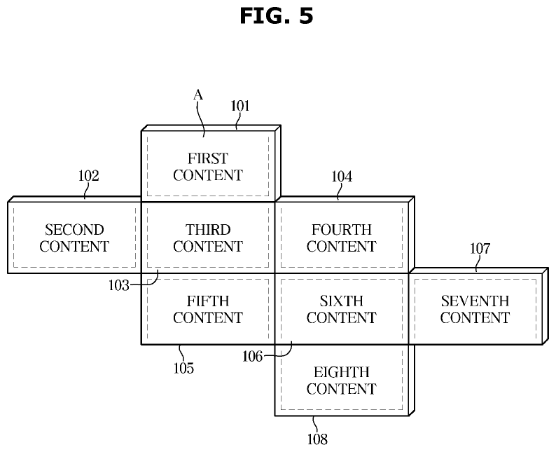

The plurality of displays 100 may include a first display 101, a second display 102, a third display 103, and the like, and may be configured by arranging the plurality of displays 100 in a regular shape or an irregular shape. For example, the plurality of displays 100 may be regularly arranged in 2×2, 3×3, and may be irregularly arranged as illustrated in FIG. 5. In addition, some of the plurality of displays 100 may be disposed vertically instead of horizontally. For example, when a display having a 16:9 resolution is disposed vertically, a content having an output ratio of 9:16 may be output.

The controller 300 may be connected to the plurality of displays 100 and may generate a new layout by referring to size information, arrangement information, array information, resolution information, and rotation information of each display apparatus. In addition, when the content is transmitted to the signage apparatus 1, the controller 300 may determine properties of the content to select a playable layout, and enable the content to be output through the selected layout.

The controller 300 may be connected to the display apparatus having a resolution of various ratios, and is composed of elements such as a video, an image, and a text to reproduce. The controller 300 may be built into the display apparatus and operated. In addition, the controller 300 may be implemented as a separate external device and may be connected so as to integrate and control the plurality of displays 100. In addition, it goes without saying that the controller 300 may be implemented in an integrated form with the server 10.

Next, a configuration and an operation of the signage apparatus 1 according to the embodiment will be described in detail with reference to FIG. 2.

Referring to FIG. 2, the signage apparatus 1 may include the plurality of displays 100, a content provider 200, and the controller 300. However, only the components related to the embodiment of the present disclosure are illustrated in FIG. 2. Accordingly, those of ordinary skill in an art to which the present disclosure pertains can recognize that other general-purpose components may be further included in addition to the components illustrated in FIG. 2. In addition, it should be noted that each of the components of the signage apparatus 1 illustrated in FIG. 2 represents functional elements that are functionally divided, and at least one component may be implemented in the form integrated with each other in the actual physical environment.

The plurality of displays 100 may output the content processed by the signage apparatus 1. The plurality of displays 100 may be arranged in the regular shape or the irregular shape to constitute a variety of video walls. Each display apparatus constituting the plurality of displays 100 may include at least one of a liquid crystal display, a thin film transistor-liquid crystal display, an organic light-emitting diode, a flexible display, and a 3D display. In addition, the display apparatus may be implemented as a touch screen including a touch recognition module.

The plurality of displays 100 may include the first to third displays 101, 102, and 103. Although not illustrated in FIGS. 1 and 2, the plurality of displays 100 may be connected to each other through a daisy chain type wiring, and the plurality of displays 100 may be wirelessly connected to enable mutual communication. For example, the plurality of displays 100 may be provided to transmit/receive predetermined data or information to and from each other through a wireless communication network. In addition, although only three displays are illustrated in the plurality of displays 100 in FIGS. 1 and 2, it goes without saying that more displays may be included. Meanwhile, as described above, the array in which the plurality of displays 100 may be arranged may follow various arrays.

The content provider 200 includes a storage 210 and a communication module 220 and may provide stored content or content received from the server 10 to the signage apparatus 1.

The storage 210 may store a program for controlling the operation of the signage apparatus 1 and data related to the content to be reproduced by the signage apparatus 1. The storage 210 may temporarily or permanently store the content, and may temporarily or permanently store data generated during the operation of the signage apparatus 1 or received from the server 10.

The storage 210 may be implemented using a memory 211. In addition, the storage 210 may be implemented using a magnetic drum storage device, a magnetic disc storage device, and/or a semiconductor storage device. Here, the semiconductor storage device may be implemented using one or more volatile memory devices such as random access memory (RAM), and/or may be implemented using one or more non-volatile memory devices such as read only memory (ROM), programmable ROM (PROM), erasable programmable ROM (EPROM), electrically erasable programmable ROM (EEPROM), or NAND flash memory.

The communication module 220 may include one or more modules for connecting the signage apparatus 1 to other external devices or to a wired/wireless network. The communication module 220 may form the wired/wireless network with the server 10 capable of providing the content. Accordingly, the signage apparatus 1 may receive the content from the server 10 through the communication module 220.

Here, a wireless internet module refers to a module for a wireless internet access, and may be built-in or external to the multi-vision. A wireless internet technologies may include wireless LAN (WLAN) (Wi-Fi), wireless broadband (Wibro), world interoperability for microwave access (Wimax), high speed downlink packet access (HSDPA), and long term evolution (LTE).

A short-range communication module refers to a module for a short-range communication. As a short-range communication technology, Bluetooth, Radio Frequency Identification (RFID), infrared data association (IrDA), Ultra Wideband (UWB), ZigBee, and the like may be used.

The controller 300 may control an overall operation of the signage apparatus 1. That is, the controller 300 may control the operation of each of the components of the signage apparatus 1. The controller 300 may generate the new layout forming the output area of at least one display among the plurality of displays 100 and control to output at least one content through the new layout.

The controller 300 may determine the array and arrangement of the plurality of displays 100 included in the signage apparatus 1, and generate the new layout that forms the output area of some of the displays 100. In addition, when the new layout is generated, the controller 300 may control at least one display apparatus to output the content through the new layout.

The controller 300 may be implemented with at least one processor 301. The controller 300 may communicate with each of the plurality of displays 100 individually and independently, or may communicate with the second display 102 via the first display 101.

The controller 300 may be configured to include a Central Processing Unit (CPU), a Micro Processor Unit (MPU), a Micro Controller Unit (MCU), or any type of processor 301 well known in a technical field of the present disclosure. In addition, the controller 300 may perform an operation on at least one application or program for executing the operation according to the embodiments of the disclosed invention.

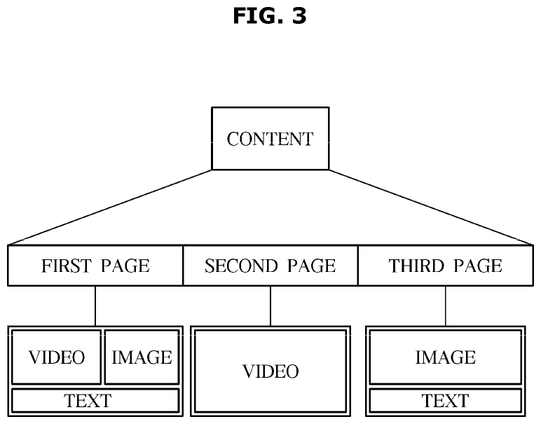

Meanwhile, in the above, the overall configuration and operation of the signage apparatus 1 and the system in which the signage apparatus 1 is implemented have been described. The signage apparatus 1 may output the contents to the plurality of displays arranged in various ways. In the following, the content provided by the signage apparatus 1 will be described in more detail with reference to FIG. 3.

FIG. 3 is a view for describing a content referred to in an embodiment.

In order to effectively provide the information such as the video, the image, and the text, the content should be arranged with output elements according to the size and ratio of the display apparatus. For example, the content is written based on FHD (1920×1080), and when it is enlarged or reduced according to the ratio of the display apparatus to be reproduced on the display apparatus, the content may be reproduced in an intended shape.

Also, the content may be authored in the plurality of pages. The display apparatus may reproduce each page according to a predetermined time sequence. Since the shape of the output area of the display apparatus is determined, a method of sequentially reproducing the plurality of pages by arranging the videos, the images and the texts according to the shape of the output area and organizing them for each page may be adopted.

The content described above may be output through various new layouts. Hereinafter, a detailed process of generating the new layout will be described in detail. For reference, the new layout is a shape obtained by dividing or integrating the output area of an individual display apparatus, and may indicate a boundary unit in which the content is output.

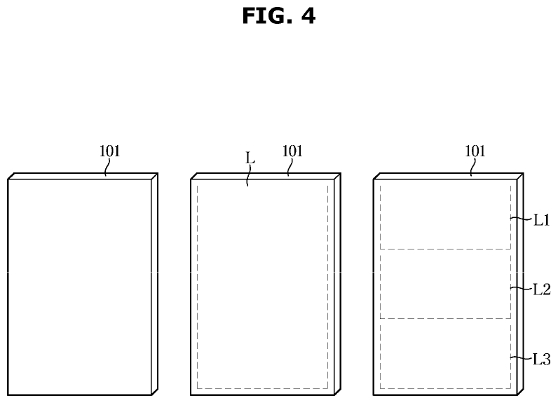

FIG. 4 is a view for describing a divided layout referred to in an embodiment. For convenience of description of the present embodiment, the first display 101 of the plurality of displays will be described as an example.

The signage apparatus 1 may consider one monitor or the entire monitor as one playback area, but may consider a method of reproducing the content in several divided areas as needed.

For example, when the first display 101 having the 16:9 resolution is vertically arranged, the ratio of an output area L may be 9:16. Here, in the output area L, the content provided in a 9:16 ratio may be reproduced. When three horizontally arranged 16:9 contents are arranged vertically side-by-side, in the output area L, it will be a 16:27 ratio, which will approximate the 9:16 ratio with a 9:15.2 ratio. Accordingly, the vertically arranged first display 101 may reproduce content by dividing the 16:9 ratio content into three areas L1, L2, and L3 in a vertical direction. However, this is only an example, and when the first display 101 is arranged horizontally, the content having the 9:16 ratio may be divided into three areas in a horizontal direction and played. In addition, when the first display 101 has a different resolution, for example, a ratio of 21:9 or 32:9, it is possible to output various contents in one output area through an appropriate number of divisions.

In an embodiment, the controller 300 may generate the new layout by dividing the output area of one of the plurality of displays 100. Here, as described above, a number of new layouts may be adjusted by referring to the ratio of the output area.

In addition, in the embodiment, the plurality of displays 100 have the 16:9 resolution and may be arranged in the regular or irregular shape. When any one of the arranged displays is horizontally arranged, the controller 300 may generate three new layouts having the 9:16 ratio in the horizontal direction. When any one of the arranged displays is vertically arranged, the controller 300 may generate three new layouts having the 16:9 ratio in the vertical direction.

In the above, the new layout generated by dividing the output area has been described with reference to FIG. 4. Hereinafter, various embodiments of generating the new layout by integrating the output area will be described. Hereinafter, in the embodiments of FIGS. 5 to 8, it is assumed that each of the first to eighth displays 101 to 108 is an apparatus having the 16:9 resolution. However, note that this is for convenience of description, is not limited to a specific resolution or ratio, and may be applied to the display apparatus having various resolutions or ratios.

FIG. 5 is a view illustrating a video wall of an irregular signage apparatus according to an embodiment. A video wall refers to a form of the plurality of displays according to various arrays and arrangements. Referring to FIG. 5, the irregular signage apparatus according to the present embodiment may include the first display 101, the second display 102, the third display 103, the fourth display 104, the fifth display 105, the sixth display 106, the seventh display 107, and the eighth display 108, and each of the first to eighth displays 101 to 108 may reproduce each of the first to eighth contents. In addition, unlike illustrated, the first to eighth displays 101 to 108 may simultaneously reproduce the plurality of pages included in one content. When the first display 101 has the 16:9 resolution specification, the first content may be reproduced through a layout A having the 16:9 ratio.

The video wall illustrated in FIG. 5 may correspond to an irregular video wall, not an N×N type. In this case, the content generated exclusively for the unstructured video wall layout could be used, or the content of the 16:9 ratio that was previously authored could be simply enlarged and played back at a position of an adjacent square of the video wall layout.

The entire layout of the video wall may be set by collecting in advance the size information, the position information, and the rotation information of an actually arranged display. The contents are placed on a screen by placing the entire layout of the video wall at a time of authoring as a background and placing the videos and the images on it, predicting how it will be reproducing on the actual video wall.

Meanwhile, according to the disclosed embodiments, the new layout may be generated and the content may be reproduced through various output areas. In this case, the signage apparatus 1 may generate the new layout by referring to the size information, the position information, and the rotation information of the actually arranged display.

Particularly, the new layout may be generated based on corner information by extracting the corner information from the position information and the size information of the display. Here, the corner information may refer to a coordinate value in which the position information and the size information of the display are reflected.

In order to generate the new layout, the controller 300 may obtain the position information and the size information based on the entire layout. When a position of the third display 103 illustrated in FIG. 5 is set to be (x, y), and horizontal and vertical sizes of each display are (w, h), the corner information of the third display 103 is (x, y), (x+w, y), (x, y+h), (x+w, y+h). Here, the (x+w, y+h) of the corner information of the third display 103 may be included in the corner information of the fourth display 104, the fifth display 105, and the sixth display 106. At this time, the third display 103 may generate the new layout using the output area of the display that matches the corner information of the third display 103 as a result of determining the corner information of other displays except the third display 103 included in the entire layout. Furthermore, when the above-described method is applied to various display arrays, a display capable of providing the new layout may be determined, and thus the output area having the same various sizes and ratios may be secured.

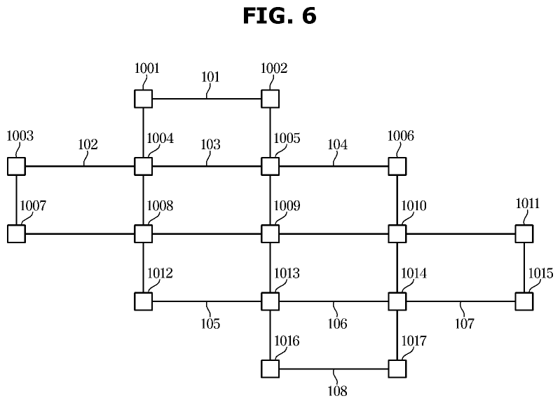

FIG. 6 is a view illustrating a sensor provided in the irregular signage apparatus illustrated in FIG. 5. The sensor applied in the embodiment may be composed of a detector and a detectable part. The sensor may receive a signal generated from the detectable part, so that a distance between the sensors and the position of each display may be determined. For example, the sensor may include a position sensor, an inductance sensor, an infrared sensor, a laser sensor, and the like, and various known sensors capable of measuring a short distance or determining the position may be applied.

For example, when each of the displays illustrated in FIG. 6 has the 16:9 resolution, the controller 300 may generate the new layout having the 16:9 ratio in which the output areas of the third display 103, the fourth display 104, the fifth display 105, and the sixth display 106 are integrated based on the positions determined through a fourth sensor 1004, a sixth sensor 1006, a fourteenth sensor 1014, and a twelfth sensor 1012.

In addition, the controller 300 may generate the new layout having the 32:9 ratio in which the output areas of each of the third display 103 and the fourth display 104 are integrated based on the positions determined by the fourth sensor 1004, the sixth sensor 1006, an eighth sensor 1008, and a tenth sensor 1010.

In addition, the controller 300 may generate the new layout having the 9:16 ratio in which the output areas of each of the first display 101, the third display 103, and the fifth display 105 are integrated based on the positions determined through the first sensor 1001, the second sensor 1002, the thirteenth sensor 1013, and the twelfth sensor 1012.

In the embodiment, the position sensor may be provided at each corner of the display in the plurality of displays, and the controller 300 may generate a new rectangular layout having the 16:9 or 9:16 ratio based on the position sensor. The signage apparatus 1 may reproduce at least one content through the generated new layout and the existing 16:9 layout. Here, the new layout may be generated based on at least one of the array information, the size information, ratio information, the resolution information, and the rotation information of the plurality of displays.

In a process of generating the layout, the controller 300 may adopt a method of finding a rectangle close to the 16:9 ratio based on four corners placed on each display, and may induce to select applicable multiple layouts.

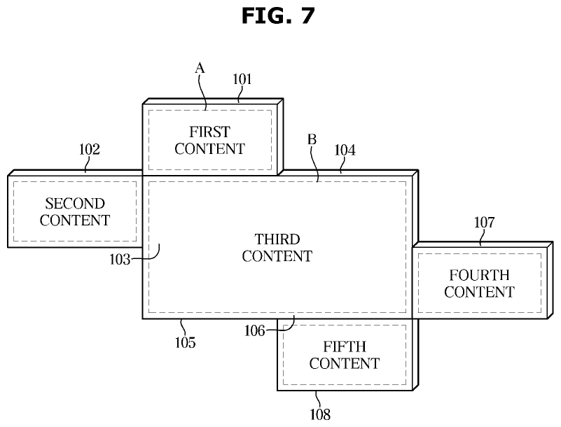

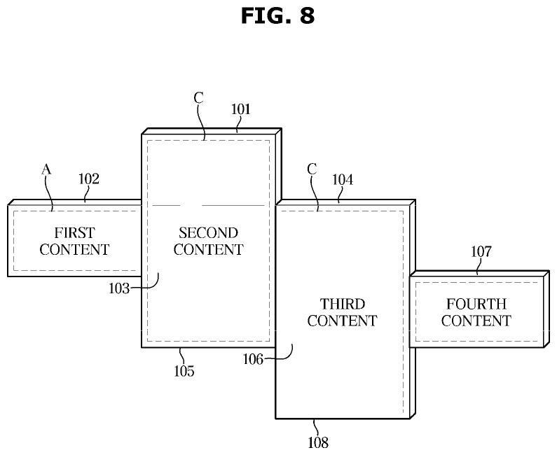

FIGS. 7 and 8 are views for describing a new layout generated by an irregular signage apparatus.

In the embodiment, the controller 300 may generate the new layout by integrating output areas of two or more displays adjacent to each other among the plurality of displays. Here, the plurality of displays may include at least one main display and at least one sub display. The main display may refer to a display in which the output area is integrated to generate the new layout, and the sub display may refer to a display to which a basic layout in which the content is reproduced through the existing output area is applied. This may be changed according to a user's setting. In this case, the controller 300 may control at least one main display to output the content compatible with the new layout by setting the new layout according to the user's setting, and control at least one sub display to output the content compatible with an existing layout.

Referring to FIG. 7, the plurality of displays may include the first to eighth displays 101 to 108 having the 16:9 resolution. However, it should be noted that, as described above, the signage apparatus 1 illustrated in FIG. 7 corresponds to the irregular video wall, and is not limited to the illustrated array, and may follow various arrays. At this time, the controller 300 may control to detect that the third, fourth, fifth and sixth displays 103 to 106 are arranged in a 2×2 array, to generate a new layout B in which the output areas of the third, fourth, fifth and sixth displays 103 to 106 are generated, and to output the content compatible with the new layout B. In this case, the new layout B may provide an area in which contents having the 16:9 ratio can be output, and the video wall capable of simultaneously providing five types of contents.

Referring to FIG. 8, the plurality of displays may include the first to eighth displays 101 to 108 having the 16:9 resolution. At this time, the controller 300 may control to detect that the first display 101, the third display 103, and the fifth display 105 are continuously arranged in the vertical direction, to generate a new layout C in which the output areas of the fifth display 105 are integrated, and to display the content compatible with the new layout. In this case, the new layout C may provide an area in which contents having the 9:16 ratio can be output, and may provide a video wall capable of simultaneously providing four types of contents.

As described above, the signage apparatus 1 may reproduce multiple contents or multiple pages by utilizing the configuration of multiple layouts. In addition, it can be seen that even though the content has a different ratio that cannot be output through the existing layout, it can be output through the new layout.

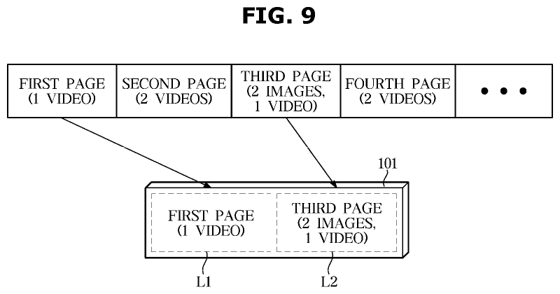

FIG. 9 illustrates a display of one of video walls for selectively multi-playing content having a plurality of pages. For convenience of description of the present embodiment, the first display 101 of the plurality of displays will be described as an example.

In order for the first display 101 to simultaneously reproduce the multiple pages, the controller 300 may determine in advance an available layout, and the first display 101 may reproduce the content through the determined layout. The controller 300 may select a layout to reproduce the content based on multiple reproducible layouts and the content output limitation of the first display 101.

Here, there is a limit to a configuration of the content that can be reproduced by the first display 101. For example, if the first display 101 supports simultaneous playback of up to two videos, the pages to be reproduced simultaneously need to be configured such that there are no more than one video. However, the content that is actually authored is authored without taking this into account.

In order to solve this problem, it is possible to overcome this limitation by simultaneously reproducing only reproducible pages with reference to a reproducing performance of the display instead of sequentially simultaneously reproducing the plurality of pages with reference to the reproducing performance of the display.

Referring to FIG. 9, when there is a limit in that the content output performance of the first display 101 cannot reproduce two videos at the same time, the controller 300 may reproduce a first page and a third page without reproducing a second page among the plurality of pages. When the reproduction of the first page is finished, the fourth page may be reproduced.

In the embodiment, the plurality of displays may include the first display having a 32:9 resolution. In this case, the controller 300 may control to generate a first new layout and a second new layout in which the output area of the first display is divided, and to sequentially output at least one page that can be output through the first new layout and the second new layout among the plurality of pages, except for pages that cannot be output by referring to the reproducing performance of the first display.

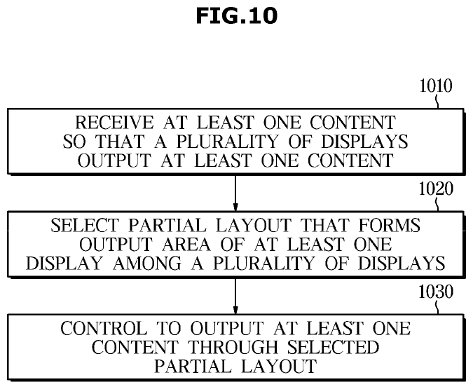

FIG. 10 is a flowchart of a method of controlling a signage apparatus according to an embodiment. This is only an embodiment for achieving the object of the disclosure, and of course, some configurations may be added or deleted as necessary. In addition, for convenience of description, the description of the operation subject of each step included in a control method of the signage apparatus 1 may be omitted.

At least one content may be received so that the plurality of displays output at least one content (1010). Here, the plurality of displays may output a plurality of contents, or may simultaneously output the plurality of pages constituting one content. The plurality of displays may be arranged in the regular or irregular shape to constitute the variety of video walls.

The new layout that forms the output area of the at least one display among the plurality of displays is generated (1020). Here, the output area of the at least one display may be a combination of the output areas of adjacent displays, or may be divided into the output area having the specific ratio of the output area of one display.

The controller 300 may control to output at least one content through the new layout (1030). The new layout may provide at least some of the output areas among the plurality of displays. Among the plurality of displays, the content compatible with the existing layout and the output ratio may be output to the display in which the new layout is not generated. Accordingly, the video wall through the plurality of displays may simultaneously provide contents having various output ratios in various forms.

The disclosed embodiments may be implemented in the form of a recording medium storing computer-executable instructions that are executable by a processor. The instructions may be stored in the form of a program code, and when executed by a processor, the instructions may generate a program module to perform operations of the disclosed embodiments. The recording medium may be implemented non-transitory as a computer-readable recording medium.

The non-transitory computer-readable recording medium may include all kinds of recording media storing commands that can be interpreted by a computer. For example, the non-transitory computer-readable recording medium may be, for example, ROM, RAM, a magnetic tape, a magnetic disc, flash memory, an optical data storage device, etc.

Embodiments of the disclosure have thus far been described with reference to the accompanying drawings. It should be obvious to a person of ordinary skill in the art that the disclosure may be practiced in other forms than the embodiments as described above without changing the technical idea or essential features of the disclosure. The above embodiments are only by way of example, and should not be interpreted in a limited sense.

1. A signage apparatus comprising:
a plurality of displays in an irregular shape;
a storage providing at least one content; and
a controller configured to generate a new layout forming an output area of at least one display among the plurality of displays, and to control to output the at least one content through the new layout.

2. The signage apparatus according to claim 1, wherein the controller is configured to generate the new layout by integrating output areas of two or more displays adjacent to each other among the plurality of displays.

3. The signage apparatus according to claim 1, wherein the controller is configured to generate the new layout by dividing the output area of the display.

4. The signage apparatus according to claim 1, wherein the controller is configured to generate the new layout based on at least one of array information, size information, ratio information, resolution information, and rotation information of the plurality of displays.

5. The signage apparatus according to claim 1, wherein:
a position sensor is provided at each corner of the display in the plurality of displays; and
the controller is configured to generate a new rectangular layout with a 16:9 or 9:16 ration based on the position sensor.

6. The signage apparatus according to claim 1, wherein the controller is configured to determine a ratio of the new layout and control to output a content compatible with the ratio.

7. The signage apparatus according to claim 1, wherein:
the plurality of displays comprises at least one main display and at least one sub-display; and
the controller is configured to control the at least one main display to output a content compatible with the new layout by setting the new layout according to a user's setting and the at least one sub display to output a content compatible with an existing layout.

8. The signage apparatus according to claim 1, wherein:
the plurality of displays have a 16:9 resolution; and
the controller is configured to:
based on the display being a horizontal array, generate three new layouts with a 9:16 ratio in a horizontal direction, and
based on the display being a vertical array, generate three new layouts with a 16:9 ratio in the vertical direction.

9. The signage apparatus according to claim 1, wherein:
the plurality of displays comprises first, second, third and fourth displays having a 16:9 resolution; and
the controller is configured to:
detect that the first, second, third, and fourth displays are arranged in a 2×2 array,
generate a new layout in which the output areas of the first, second, third, and fourth displays are integrated, and
control to output a content compatible with the new layout.

10. The signage apparatus according to claim 1, wherein:
the plurality of displays comprises first, second, and third displays having a 16:9 resolution; and
the controller is configured to:
detect that the first, second, and third displays are continuously arranged in a vertical direction,
generate a new layout in which the output areas of the first, second, and third displays are integrated, and
control to output a content compatible with the new layout.

11. The signage apparatus according to claim 1, wherein:
the content comprises a plurality of pages authored sequentially;
the plurality of displays comprise a first display having a 32:9 resolution; and
the controller is configured to:
generate a first new layout and a second new layout in which an output area of the first display is divided, and
control to sequentially output at least one page that can be output through the first new layout and the second new layout among the plurality of pages.

12. A method of controlling a signage apparatus, the signage apparatus includes a plurality of displays, the method comprising:
receiving, by a controller, at least one content so that the plurality of displays output the at least one content, and arranging the plurality of displays in an irregular shape;
selecting, by the controller, a partial layout forming an output area of at least one display from among the plurality of displays; and
controlling, by the controller, to output the at least one content through the partial layout.

13. The method according to claim 12, wherein the selecting of the partial layout forming the output area of at least one display from among the plurality of displays comprises:
generating the partial layout by integrating output areas of two or more displays adjacent to each other among the plurality of displays.

14. The method according to claim 12, wherein the selecting of the partial layout forming the output area of at least one display from among the plurality of displays comprises:
generating the partial layout by integrating output areas of two or more displays adjacent to each other.

15. The method according to claim 12, wherein the selecting of the partial layout forming the output area of at least one display from among the plurality of displays comprises:
generating the partial layout by dividing the output area of the display.
